(19) United States
(12) Patent Application Publication
(10) Pub. No.: US 2026/0230148 A1
(43) Pub. Date: Aug. 6, 2026

(54) Channel Quality Indicator (CQI) Determination for Channel State Information (CSI) Compression Using Artificial Intelligence(AI)/Machine Learning (ML) Models in Wireless Communication Networks

(71) Applicant: Apple Inc., Cupertino, CA (US)

(72) Inventors: Konstantinos Sarrigeorgidis, Los Gatos, CA (US); Yang Tang, San Jose, CA (US); Xiang Chen, Campbell, CA (US); Jie Cui, San Jose, CA (US)

(21) Appl. No.: 19/226,141

(22) Filed: Jun. 2, 2025

(30) Foreign Application Priority Data
Jan. 31, 2025 (GR) 20250100073

(51) Int. Cl. H04B 7/06; H04B 17/309; H04L 41/16

(52) U.S. Cl. CPC H04B 7/0632; H04B 7/0626; H04B 7/0639; H04B 17/346; H04L 41/16

(57) ABSTRACT

Apparatuses, systems, and methods for determining Channel Quality Indicator (CQI) for Channel State Information (CSI) compression using AI/ML-based models are described including systems, methods, and mechanisms for a user equipment device (UE) to report an adjusted Channel Quality Indicator (CQI) to a base station (BS). In one example, adjusted Channel Quality Indicator (CQI) may be based on differences in precoding matrices.

### PRIORITY DATA

This application claims priority to foreign Patent Application No. GR20250100073, filed in Greece on Jan. 31, 2025, which is incorporated herein by reference.

### FIELD

The invention relates to wireless communications, and more particularly to apparatuses, systems, and methods for determining Channel Quality Indicator (CQI) for Channel State Information (CSI) compression using AI/ML-based models.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards.

Long Term Evolution (LTE), also referred to as the Evolved Universal Terrestrial Radio Access Network (E-UTRAN, has been the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of the Third Generation Partnership Project (3GPP) Fifth Generation New Radio (5G NR) was standardized. 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

5G-NR provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

One aspect of wireless communication systems, e.g., systems for NR cellular wireless communications, is the measurement of reference signals, including Channel State Information reference signals (CSI-RS) and Channel State Information (CSI) reporting

### SUMMARY

Embodiments relate to wireless communications, and more particularly to apparatuses, systems, and methods to determine Channel Quality Indicator (CQI) for Channel State Information (CSI) compression using AI/ML-based models.

Embodiments relate to wireless communications, and more particularly to apparatuses, systems, and methods for a device configured for communicating in a wireless communication network, comprising: one or more processors, coupled to a memory, configured to encode an optimal precoding matrix according to an AI/ML-based model; signal the encoded optimal precoding matrix to a base station (BS); receive a precoding matrix reconstructed from the encoded optimal precoding matrix from the base station (BS); and calculate a Channel Quality Indicator (CQI) adjustment value based on differences between the optimal precoding matrix and the precoding matrix reconstructed from the encoded optimal precoding matrix.

Other embodiments relate to a user equipment comprising: one or more processors, coupled to a memory, configured to: encode an optimal precoding matrix according to an AI/ML-based model; signal the encoded optimal precoding matrix to a base station (BS); calculate a Channel Quality Indicator (CQI) value, wherein the Channel Quality Indicator (CQI) value is based the optimal precoding matrix; apply a Channel Quality Indicator (CQI) adjustment value to the calculated Channel Quality Indicator (CQI) value; and report an adjusted Channel Quality Indicator (CQI) to the base station (BS).

The techniques described herein may be implemented in and/or used with a number of different types of devices, including but not limited to base stations, access points, cellular phones, tablet computers, wearable computing devices, portable media players, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates an example of a device in accordance with some embodiments.

FIG. 9 illustrates an example baseband circuitry in accordance with some embodiments.

FIG. 10 illustrates an example of a control plane protocol stack in accordance with some embodiments.

FIG. 11 illustrates an example timing diagram of utilizing CSI feedback, according to some embodiments.

FIG. 12 illustrates an example of a two-sided AI/ML-based model for CSI compression, according to some embodiments.

FIG. 13 illustrates an example of a one-sided AI/ML-based model for CSI prediction, according to some embodiments.

FIG. 14 illustrates an example of an AI/ML-based model for joint CSI prediction and compression, according to some embodiments.

FIG. 15 illustrates an example of a two-sided AI/ML-based model for CSI compression with CQI determination, according to some embodiments.

FIG. 16 illustrates an example of a CQI adjustment calculator, according to some embodiments.

FIG. 17 illustrates an example timing diagram for utilizing CQI determination with CSI compression using a two-sided AI/ML-based model, according to some embodiments.

FIG. 18 illustrates an example timing diagram for utilizing CQI determination with CSI compression using a two-sided AI/ML-based model, according to some embodiments.

FIG. 19 illustrates a block diagram of an example of a method to determine Channel Quality Indicator (CQI) for Channel State Information (CSI) compression using AI/ML-based models, according to some embodiments.

FIG. 20 illustrates a block diagram of an example of a method to determine Channel Quality Indicator (CQI) for Channel State Information (CSI) compression using AI/ML-based models, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning and at least includes a wireless communication network or RAT that is serviced by wireless LAN (WLAN) access points, and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by the Third Generation Partnership Project (3GPP) standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system can update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as used by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

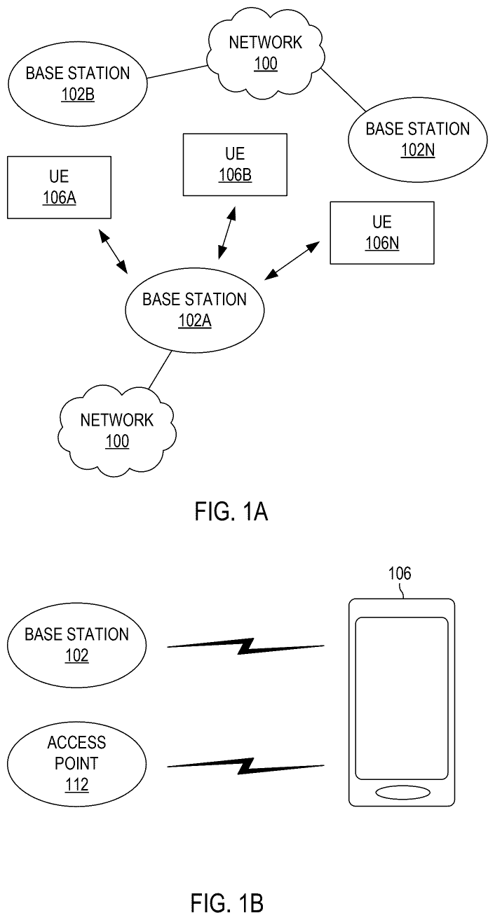

### FIGS. 1A and 1B: Communication Systems

FIG. 1A illustrates a simplified example of a wireless communication system, according to some embodiments. It is noted that the system of FIG. 1A is merely one example of a possible system, and that features of this disclosure may be implemented in any of the various systems, as desired.

As shown, the example wireless communication system includes a base station 102A which communicates over a transmission medium with one or more user devices 106A, 106B, etc., through 106N. The user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE (E-UTRAN), it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network (NW) 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio May couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE (E-UTRAN) or 5G NR (or LTE or 1×RTT or LTE or GSM), and separate radios for communicating using each of Wi-Fi and Bluetooth. Other configurations are also possible.

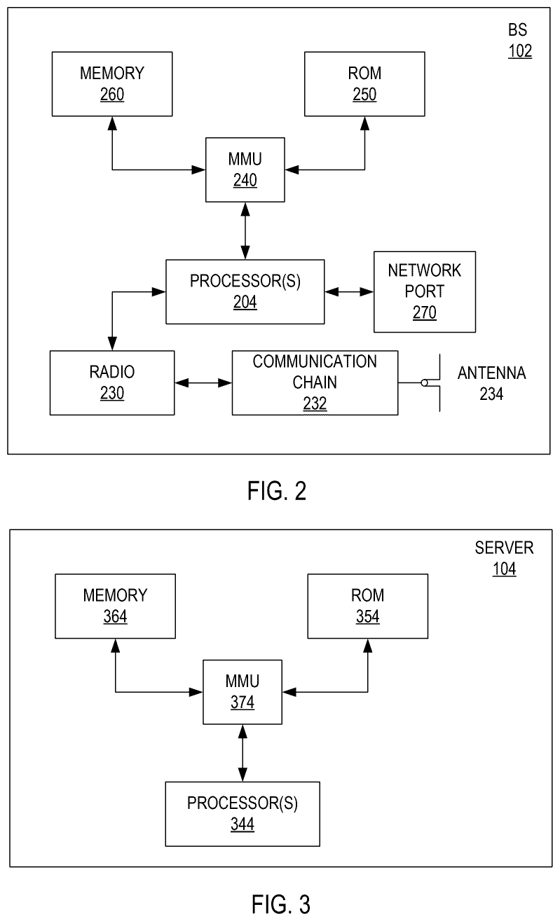

### FIG. 2: Block Diagram of a Base Station

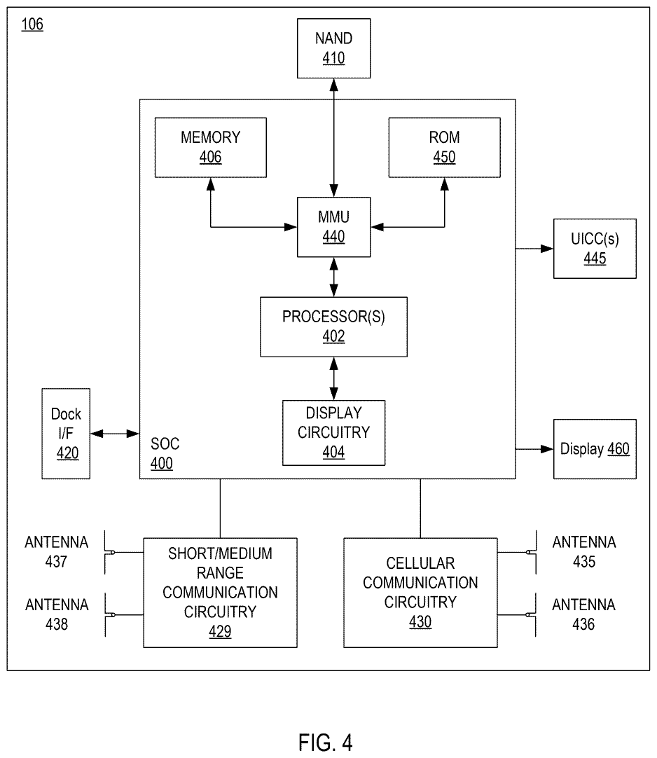

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102 and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

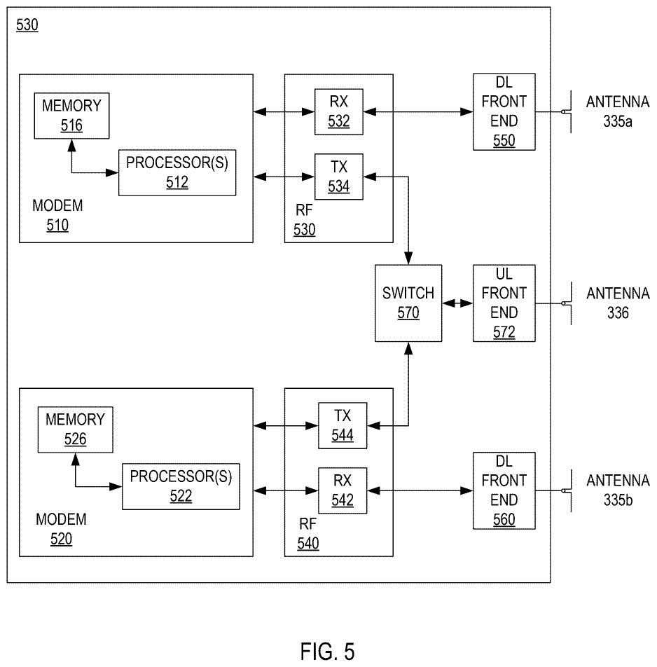

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on the corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for determining Channel Quality Indicator (CQI) for Channel State Information (CSI) compression using AI/ML-based models, as further described herein.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

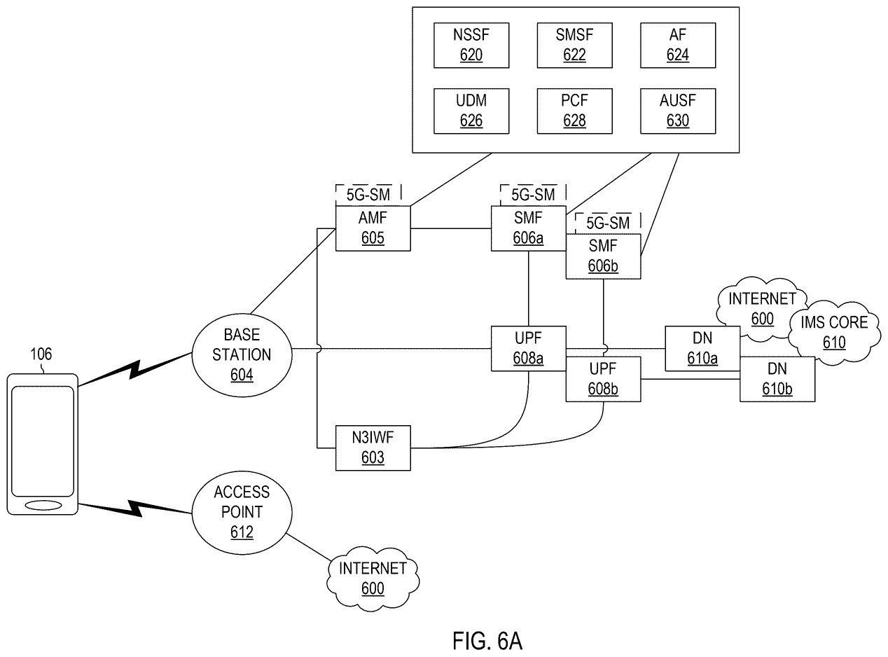

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods determining Channel Quality Indicator (CQI) for Channel State Information (CSI) compression using AI/ML-based models, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for performing methods for determining Channel Quality Indicator (CQI) for Channel State Information (CSI) compression using AI/ML-based models, as further described herein, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

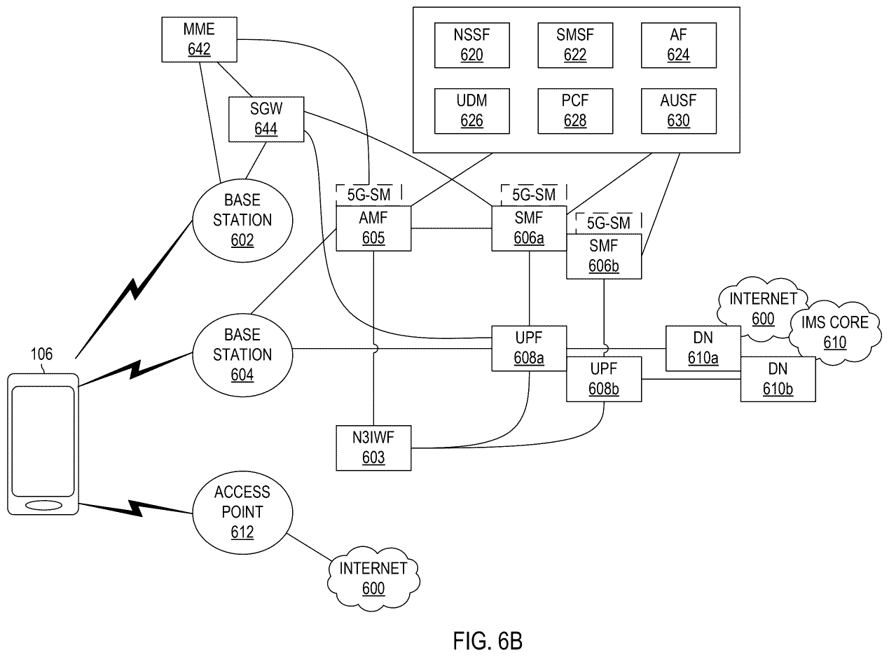

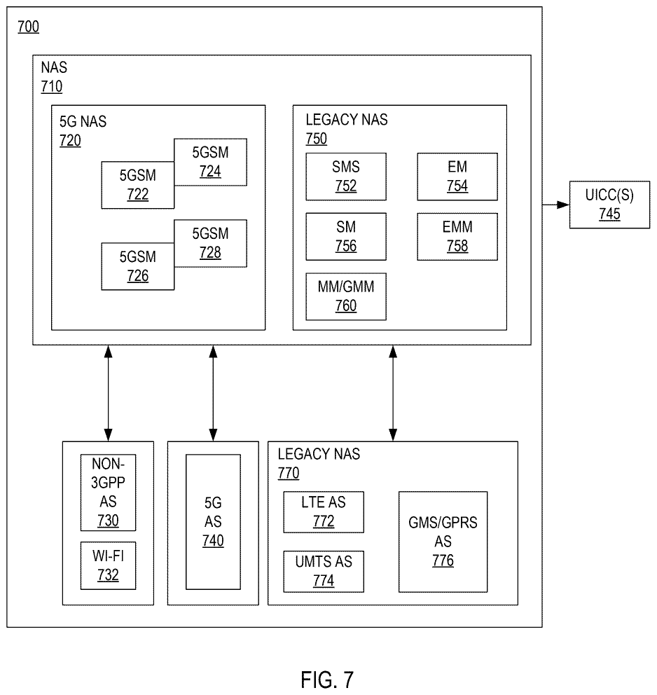

FIGS. 6A, 6B, and 7: 5G Core Network Architecture-Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 605 may be connected to (or in communication with) the SMF 606a. Further, the gNB 604 may be in communication with (or connected to) the UPF 608a, which may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for determining Channel Quality Indicator (CQI) for Channel State Information (CSI) compression using AI/ML-based models, as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). The baseband processor architecture 700 can be in communication with one or more UICC(s) 745. Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, and so forth) for both accesses.

Note that in various embodiments, one or more of the above-described functional entities of the 5G NAS and/or 5G AS may be configured to perform methods for determining Channel Quality Indicator (CQI) for Channel State Information (CSI) compression using AI/ML-based models, as further described herein.

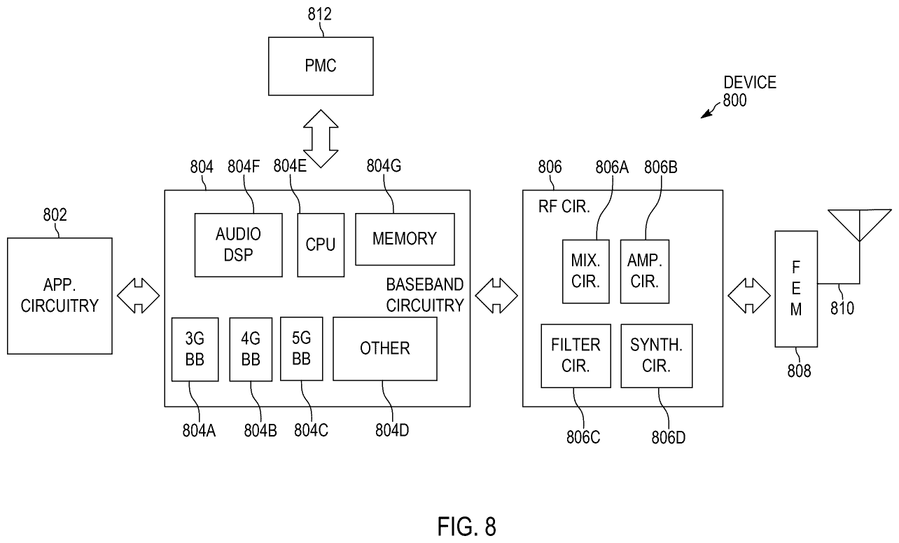

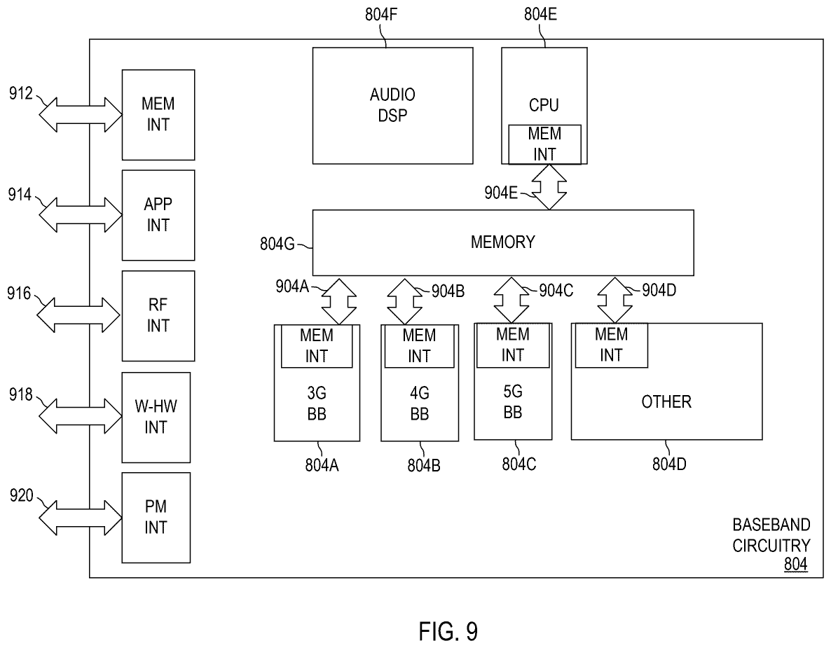

### FIGS. 8 and 9: Device Components

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802 and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals, and the input baseband signals may be analog baseband signals, although the scope of the embodiments is not limited in this respect. In some alternate embodiments, the output baseband signals, and the input baseband signals may be digital baseband signals. In these alternate embodiments, the RF circuitry 806 may include an analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage-controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD), and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used to execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

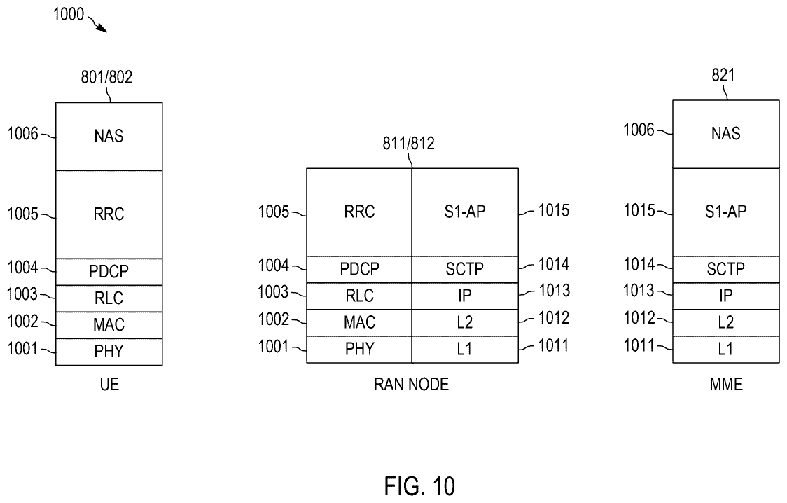

### FIG. 10: Control Plane Protocol Stack

FIG. 10 is an illustration of a control plane protocol stack in accordance with some embodiments. In one embodiment, a control plane 1000 may be a communications protocol stack between one or more UEs such as, for example, UE 801 (or alternatively, the UE 802), and/or one or more RAN nodes 811 (or alternatively, the RAN node 812), and a mobility management entity (MME) 821.

The PHY layer 1001 may transmit or receive information used by the MAC layer 1002 over one or more air interfaces. The PHY layer 1001 may further perform link adaptation or adaptive modulation and coding (AMC), power control, cell search (e.g., for initial synchronization and handover purposes), and other measurements used by higher layers, such as the RRC layer 1005. The PHY layer 1001 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1002 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1003 may operate in a plurality of modes of operation, including: Transparent Mode (TM), Unacknowledged Mode (UM), and Acknowledged Mode (AM). The RLC layer 1003 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1003 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1004 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1005 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

In one example, a UE (e.g., UE 106A-N) and a RAN node (e.g., base station 102) 811 may utilize a Uu interface (e.g., an LTE-Uu interface) to exchange control plane data via a protocol stack comprising the PHY layer 1001, the MAC layer 1002, the RLC layer 1003, the PDCP layer 1004, and the RRC layer 1005.

The non-access stratum (NAS) protocols 1006 form the highest stratum of the control plane between the UE (e.g., UE 106A-N) 801 and an MME 821. The NAS protocols 1006 support the mobility of the UE (e.g., UE 106A-N) 801 and the session management procedures to establish and maintain IP connectivity between the UE (e.g., UE 106A-N) 801 and a P-GW.

The S1 Application Protocol (S1-AP) layer 1015 may support the functions of the S1 interface and comprise Elementary Procedures (EPs). An EP is a unit of interaction between a RAN node (e.g., base station 102) 811 and the CN. The S1-AP layer 1015 services may comprise two groups: UE-associated services and non UE-associated services. These services perform functions including but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1014 may ensure reliable delivery of signaling messages between the RAN node (e.g., base station 102) 811 and a MME 821 based, in part, on the IP protocol, supported by the IP layer 1013. The L2 layer 1012 and the L1 layer 1011 may refer to communication links (e.g., wired or wireless) used by the RAN node (e.g., base station 102) and the MME to exchange information.

The RAN node (e.g., base station 102) 811 and the MME 821 may utilize an S1-MME interface to exchange control plane data via a protocol stack comprising the L1 layer 1011, the L2 layer 1012, the IP layer 1013, the SCTP layer 1014, and the S1-AP layer 1015.

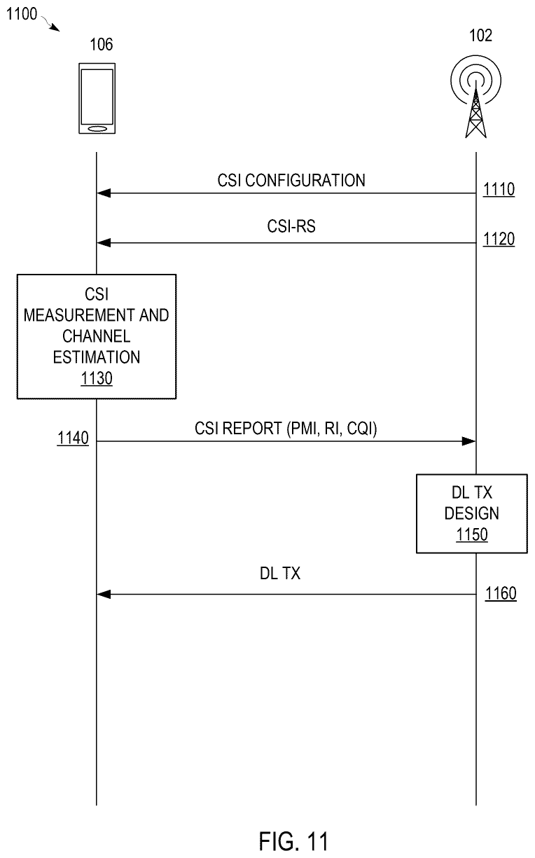

### FIG. 11: CSI Feedback

In 3GPP standards development, channel state information (CSI) feedback has been an important topic in almost every 3GPP standards release. CSI includes information regarding the multipath wireless channel between a gNB and a UE. A UE can measure downlink reference signals, compute downlink CSI, and provide a CSI report to the gNB. CSI codebook design has been focused on feedback based on a current CSI reference signal (CSI-RS) measurement. FIG. 11 illustrates an example timing diagram 1100 of utilizing CSI feedback, according to some embodiments. As illustrated in FIG. 11, a base station 102 (e.g., gNB) transmits a CSI measurement configuration to UE 106 at 1110. A CSI measurement configuration provides instructions for the UE 106 to measure CSI reference signals (CSI-RS). A CSI configuration may include information about the types of reference signals and the time and/or frequency to measure reference signals. Base station 102 transmits a CSI-RS to UE 106 at 1120. UE 106 performs measurements on the CSI-RS and performs channel estimation at 1130. That is, for example, UE 106 may estimate a raw channel matrix based on measurements. Based on the estimated raw channel matrix, UE 106 provides feedback to the BS 102 at 1140. As illustrated in FIG. 11, this feedback may generally be referred to as a CSI report. A CSI report may include various types of feedback information and may further represent the estimated raw channel matrix in various ways. For example, a precoding matrix may be derived from the raw channel matrix. Further, a precoding matrix may be indexed according to codebooks at UE 106 and BS 102, (e.g., a Type I or Type II codebook) and a CSI report may include a precoding matrix index (PMI) (i.e., precoding codeword or precoding matrix indicator) from which BS 102 can derive a precoding matrix using the shared codebook. A CSI may include a Rank Indicator (RI) which indicates the suggested number of layers in the downlink transmission. A CSI report may further include a Channel Quality Indicator (CQI), which represents the channel quality. BS 102 may design a downlink transmission based on the feedback at 1150. That is, for example, BS 102 may select a channel for a downlink transmission based on the CSI report. It should be noted that in most cases, BS 102 usually applies the precoding matrix corresponding to the PMI reported by the UE 106. BS 102 performs the downlink transmission according to the design at 1160. It should be noted that based on the PMI construction algorithm used by UE 106, it is feasible for UE 106 to construct the PMI and use the constructed PMI for CQI calculation. In this manner, the precoding matrix used in a CQI calculation at UE 106 is the same as the precoding matrix reported by UE 106 to the BS 102. Thus, when UE 106 computes CQI, it can assume that the precoding matrix applied by the BS 102 during the downlink transmission is the same as the precoding matrix indicated by the reported PMI.

It should be noted that CSI feedback may incur significant overhead. That is, for example, frequent signaling of CSI reports from multiple UEs may incur significant overhead in the communication bandwidth. The feedback overhead can be substantial due to the high dimension of the CSI in massive MIMO systems. Further, CSI feedback performance may be impacted by channel aging. That is, in an implemented system, channel characteristics are inherently time varying, and the processing delays and UE mobility may cause a channel estimated from a CSI-RS to degrade by the time a downlink transmission occurs according to the downlink derived according to the CSI.

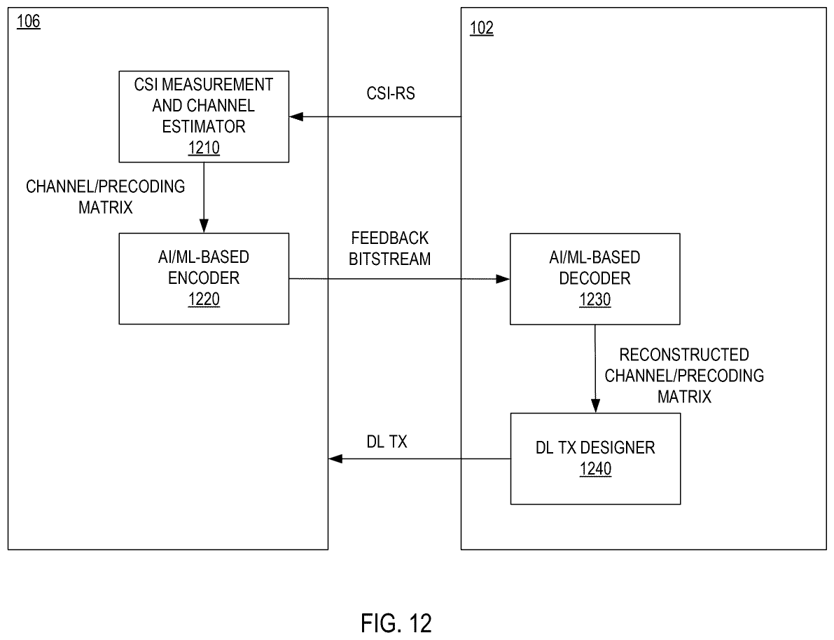

FIGS. 12, 13, and 14 AI/ML based CSI Feedback Compression and CSI Prediction

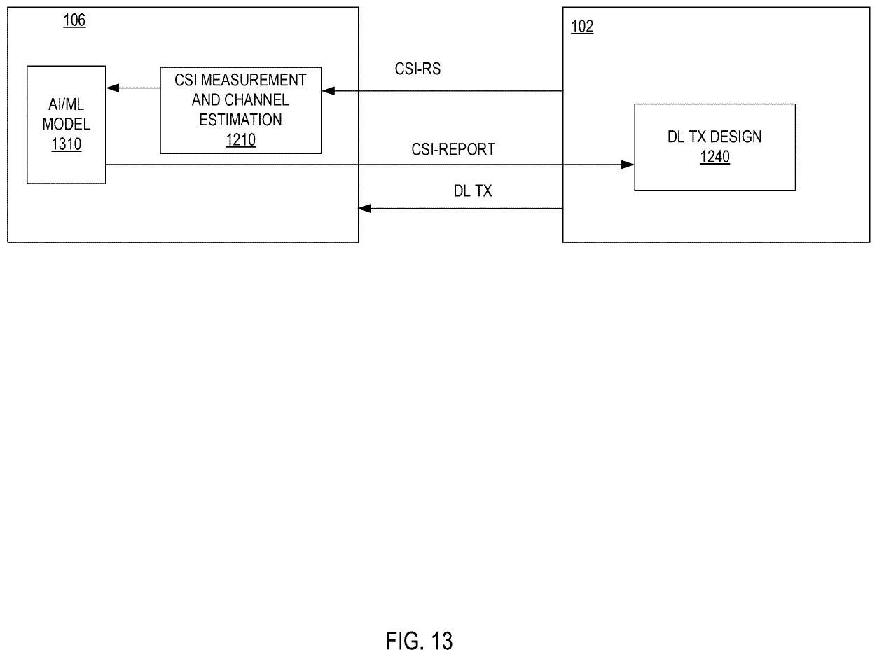

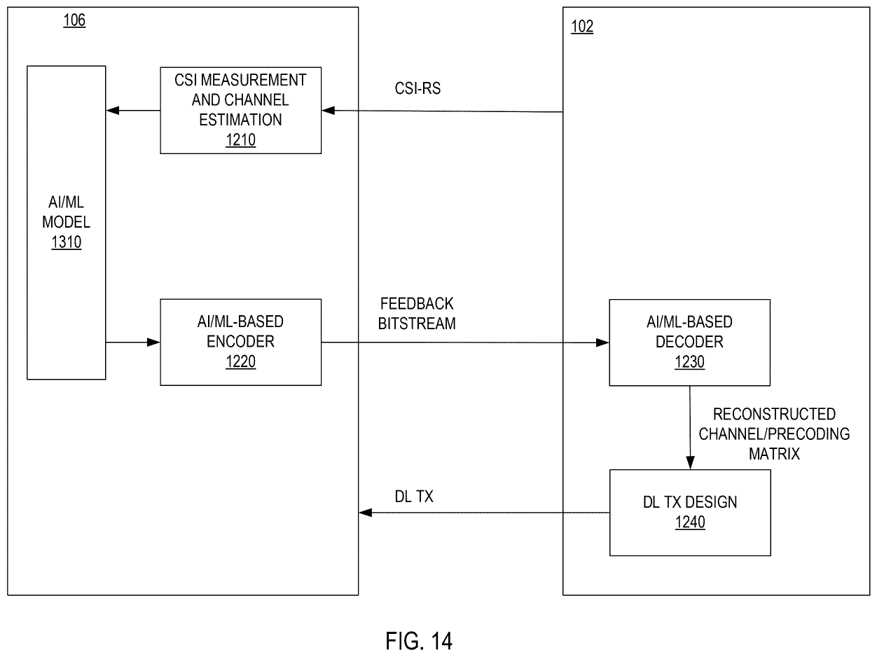

One way of reducing the amount of feedback at the UE is through the use of CSI compression and CSI prediction using Artificial Intelligence (AI)/Machine Learning (ML) based models. As provided in 3rd Generation Partnership Project; Technical Specification Group Radio Access Network; Study on Artificial Intelligence (AI)/Machine Learning (ML) for NR air interface (Release 18), 3GPP TR 38.843 V18.0.0 (2023 December), the 3GPP standards development, (hereinafter 3GPP TR 38.843) AI/ML-based techniques for compressing CSI feedback and AI/ML-based techniques for channel prediction are currently being studied. It should be noted that AI/ML-based may refer to various AI and Machine Learning (ML) techniques, which may be referred to as AI/ML. FIG. 12 illustrates an example of a two-sided AI/ML model for CSI compression, according to some embodiments. FIG. 13 illustrates an example of a one-sided AI/ML model for CSI prediction, according to some embodiments. FIG. 14 illustrates an example of an AI/ML model for joint CSI prediction and compression, according to some embodiments.

In the example illustrated in FIG. 12, UE 106 receives a CSI-RS and CSI Measurement and Channel Estimator 1210 measures the CSI-RS and performs channel estimation, for example, as described above. For example, CSI Measurement and Channel Estimator 1210 may derive a raw channel matrix, a precoding matrix, a PMI, a RI and/or a CQI. AI/ML-Based Encoder 1220 may receive one or more of a raw channel matrix, a precoding matrix, a PMI, a RI, and/or a CQI and generate a feedback bitstream according to AI/ML-based encoding techniques. For example, AI/ML-Based Encoder 1220 may receive a raw channel matrix and/or a precoding matrix and compress a received matrix according to several Neural Network (NN) layers, for example, one or more convolution layers, and generate a feedback bitstream. For example, AI/ML-Based Encoder 1220 may include an autoencoder. AI/ML-Based Decoder 1230 may perform reciprocal functions of AI/ML-Based Encoder 1220. That is, AI/ML-Based Decoder 1230 receives a feedback bitstream and reconstructs the corresponding information that was encoded, e.g., AI/ML-Based Decoder 1230 reconstructs a precoding matrix. Downlink Transmission Designer 1240 uses this reconstructed information to design a downlink transmission. For example, a reconstructed raw channel matrix may be used to derive a PMI, or a reconstructed precoding matrix may be used in the downlink transmission. A two-sided AI/ML model for CSI compression attempts to compress CSI feedback information and thereby reduce the overhead of CSI feedback.

In the example illustrated in FIG. 13, UE 106 receives a CSI-RS and CSI Measurement and Channel Estimator 1210 measures the CSI-RS and performs channel estimation, for example, as described above. AI/ML Model 1310 receives information from CSI Measurement and Channel Estimator 1210. For example, AI/ML Model 1310 may receive previous CSI-RS measurements and/or previous estimated raw channel matrices. AI/ML Model 1310 performs channel prediction according to a CSI prediction AI/ML model based on the received data. For example, AI/ML model 1310 may be a one-dimensional Long short-term memory (LSTM) AI/ML model for CSI prediction using a time domain. In some examples, the AI/ML model 1310 may be used for predicting time domain correlation only (such as, for example, the LSTM). In one example the time-series CSI-RS measurements may be fed into the LSTM layer, which outputs a vector capturing temporal dependencies and this vector may be fed into a fully connected (FC) layer to generate the CSI prediction output. In other examples, AI/ML model 1310 may be a two-dimensional convolutional neural network (“CNN”) AI model for CSI prediction using a time domain and a frequency domain. For example, a 2D CNN can capture a batch of input data, where each sample can comprise a time series of CSI measurements across different frequency subcarriers. This input tensor may be passed through a series of 2D convolutional layers (e.g., neural network) and enable the model to identify patterns in the CSI that extend across both time steps and subcarriers. AI/ML model 1310 may learn and provide CSI predictions across the future time steps and subcarriers based on the measurements of the CSI-RS input into the AI/ML model as training. In other examples, AI/ML model 1310 may be a three-dimensional convolutional neural network (CNN) AI/ML model for CSI prediction using a time domain and a frequency domain and a spatial (antenna) domain. As the inputs pass through the 3D convolutional layers (e.g., neural network), AI/ML model 1310 may learn and predict the future CSI values across time, frequency, and antenna (spatial) domains. It should be noted that due to different designs, the model data collection categorization information can be different.

Further, the predicted channel may then be used as a CSI-Report to provide uplink feedback to BS 102. That is, for example, a PMI may be derived from a predicted channel matrix. Downlink Transmission Designer 1240 can use this uplink feedback to design a downlink transmission for example, as described above. That is, according to CSI prediction, UE 106 may fine-tune CSI feedback using AI/ML-based encoding techniques and the fine-tuned CSI feedback may result in a downlink design which is less susceptible to channel aging. Further, in some cases, a CSI prediction can be used by the UE rather than a subsequent CSI-RS transmission. This can reduce CSI-RSs which are transmitted from the BS to the UE.

In the example illustrated in FIG. 14, UE 106 and BS 102 may use AI/ML model(s) for joint CSI prediction and compression. That is, for example, the predicted channel may be used as input to AI/ML-Based Encoder 1220 and AI/ML-Based Encoder 1220 may generate a feedback bitstream according to AI-based encoding techniques.

As described above, in a case where AI/ML-Based Encoding/Decoding is not applied, the precoding matrix used in a CQI calculation at UE 106 is generally the same as the precoding matrix that will be applied by the BS 102 during the downlink transmission. However, in a case where AI/ML-Based Encoding/Decoding is applied, the CSI information is compressed during encoding and reconstructed during decoding and the reconstructed CSI information may be different from the original CSI information (i.e., the CSI information prior to AI/ML encoding). As such, in the case where AI/ML-Based Encoding/Decoding is applied, the precoding matrix used in a CQI calculation at UE 106 may not be the same as the precoding matrix that will be applied by the BS 102 during the downlink transmission. For example, when a precoding matrix is reconstructed a BS 102 using AI/ML-Based decoding, the reconstructed precoding matrix may be different from the original precoding matrix (i.e., the precoding matrix prior to AI/ML encoding) used by UE 106 to calculate CQI.

This disclosure describes techniques for determining Channel Quality Indicator (CQI) for Channel State Information (CSI) compression using AI/ML-based models.

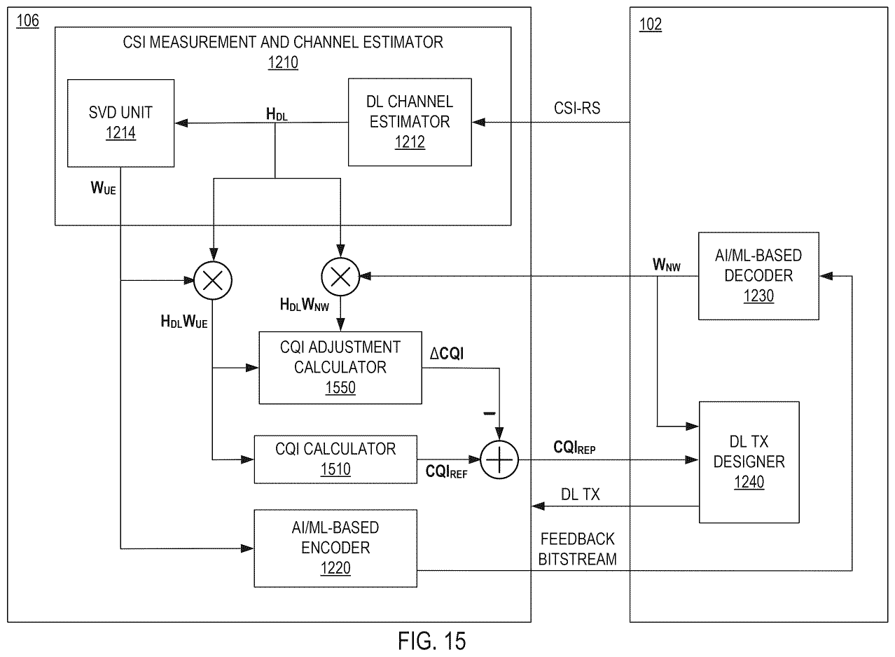

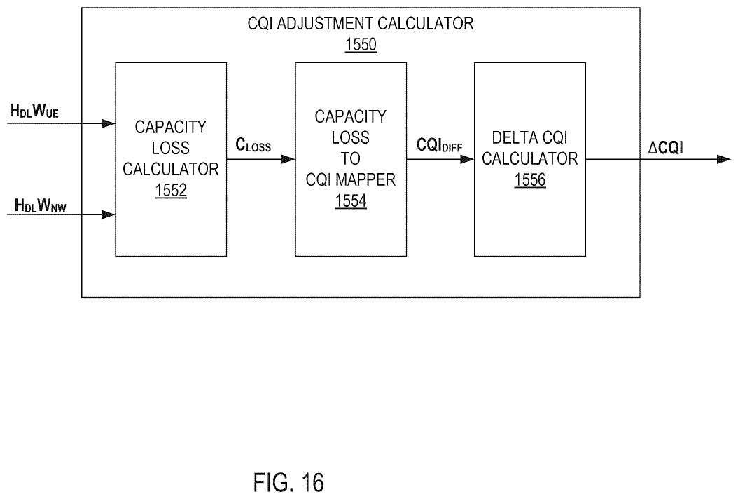

FIGS. 15 and 16: AI/ML based CSI Feedback Compression with CQI Adjustment

FIG. 15 illustrates an example of a two-sided AI/ML model for CSI compression with CQI determination, according to some embodiments. In the example illustrated in FIG. 15, UE 106 receives a CSI-RS and CSI Measurement and Channel Estimator 1210 measures the CSI-RS and performs channel estimation. In particular, CSI Measurement and Channel Estimator 1210 derives a raw channel matrix, H_{DL}, and a precoding matrix, W_{UE}. In the example illustrated in FIG. 15, CSI Measurement and Channel Estimator 1210 includes DL Channel Estimator 1212 and Singular Value Decomposition (SVD) unit 1214. Channel Estimator 1212 may be configured to derive the raw channel matrix, H_{DL}, for the DL channel based on CSI-RS measurements. Further, SVD unit 1214 may be configured to generate the precoding matrix, W_{UE}, from the raw channel matrix according to SVD. As illustrated in FIG. 15, the precoding matrix, W_{UE}, is received by AI/ML-Based Encoder 1220. AI/ML-Based Encoder 1220 may generate a feedback bitstream according to AI/ML-based encoding techniques, for example as described above. In this manner, AI/ML-Based Encoder 1220 may compress W_{UE} and signal a compressed precoding matrix to BS 102.

As further illustrated in FIG. 15, the product of H_{DL} and W_{UE} is input into CQI calculator 1510. The product H_{DL}W_{UE} provides the estimated channel and the precoding matrix which UE 106 determines should be applied to during DL transmission. As such, H_{DL}W_{UE}, corresponds to the channel quality and W_{UE} corresponds to the precoding matrix that provides the optimal channel quality, as determined by UE 106. As described above, CQI indicates the channel quality. The value of CQI value provides information about the highest modulation scheme and the code rate suitable for the downlink transmission to achieve a required error rate for given channel conditions. CQI calculator 1510 calculates a CQI value based on H_{DL}W_{UE}, as channel conditions and an acceptable corresponding transmission throughput are indicated by H_{DL}W_{UE}. Thus, as illustrated in FIG. 15, the CQI value calculated by CQI calculator 1510, CQI_{REF} is based on the precoding matrix calculated by UE 106 that provides the optimal channel quality. As described above, in a case where AI/ML-Based Encoding/Decoding is not applied, the precoding matrix used in a CQI calculation at UE 106 can be assumed to be the same as the precoding matrix that will be applied by the BS 102 during the downlink transmission. That is, referring to FIG. 15, in a case where AI/ML-Based Encoding/Decoding is not applied, W_{UE}, which is used for calculating CQI_{REF}, can be assumed to be the same precoding matrix that will be applied by the BS 102. Thus, CQI_{REF}, represents a reference CQI value based on the precoding matrix used during DL transmission being the same as W_{UE}, or the PMI corresponding W_{UE}.

However, as described above, in a case where AI/ML-Based Encoding/Decoding is applied, the precoding matrix used in a CQI calculation at UE 106 may not be the same as the precoding matrix that will be applied by the BS 102 during the downlink transmission. That is, referring to FIG. 15, the precoding matrix that will be applied by BS 102 during downlink transmission, W_{NW}, is reconstructed from the feedback bitstream by AI/ML-Based Decoder 1230 and as such, W_{NW} may not be the same as W_{UE}. In the example illustrated in FIG. 15, CQI_{REP} is the difference of CQI_{REF} and ΔCQI and UE 106 reports CQI_{REP} to BS 102. It should be noted that in some examples, UE 106 may report CQI_{REF} and ΔCQI to BS 102 and BS 102 may adjust CQI_{REF} by ΔCQI. As further illustrated in FIG. 15, CQI adjustment calculator 1550 receives H_{DL}W_{UE} and H_{DL}W_{NW} and calculates ΔCQI. As described above, W_{UE} may be referred to as the precoding matrix that provides the optimal channel quality as determined by UE 106. As described above, W_{NW} is reconstructed from an encoded W_{UE} and is the precoding matrix actually used by BS 102 during DL transmission. Thus, H_{DL}W_{UE}, corresponds to an optimal channel quality and H_{DL}W_{NW} corresponds to the actual channel quality used during DL transmission. In this manner, according to the techniques herein, CQI adjustment calculator 1550 compares an optimal channel quality and an actual channel quality and derives a CQI adjustment, ΔCQI, which is used to adjust CQI_{REF}, which is calculated using the optimal channel quality. In this manner, CQI_{REP} is a CQI value that takes into account the differences between a precoding matrix calculated at UE 106 and a precoding matrix reconstructed at BS 102. For example, if the W_{NW} is reconstructed from an encoded W_{UE} is noisy compared to the original W_{UE}, CQI_{REP} may provide a value that is reduced compared to CQI_{REF}, i.e., the highest modulation scheme and the code rate are reduced to account for W_{NW} being non-optimal.

FIG. 16 illustrates an example of a CQI adjustment calculator, according to some embodiments. As illustrated in FIG. 16, CQI adjustment calculator 1550 includes Capacity Loss Calculator 1552, Capacity Loss to CQI Mapper 1554, and Delta CQI calculator 1556. As described in further detail below, Capacity Loss Calculator 1552 calculates capacity loss, C_{LOSS}, of a DL channel based on differences in H_{DL}W_{UE} and H_{DL}W_{NW}. In particular, Capacity Loss Calculator 1552 calculates C_{LOSS} based on differences between W_{UE} and W_{NW}. For example, the more noise that is in W_{NW}, due to compression loss, may result in a higher value for C_{LOSS}. Capacity Loss to CQI Mapper 1554 receives a C_{LOSS} and determines a CQI difference value, CQI_{DIFF}. For example, a CQI value may be an integer in the range of 0 to 15 represented as a 4-bit value and as described in further detail below, C_{LOSS} is a value corresponding to a channel capacity difference. Thus, Capacity Loss to CQI Mapper 1554 maps a channel capacity difference value to a CQI_{DIFF} value which is to be subtracted from a CQI value in the range of 0 to 15. In one example, Capacity Loss to CQI Mapper 1554 may include Look-up Tables (LUT). In some examples, the LUTs may correspond to UE 106 specific implementations. For example, Capacity Loss to CQI Mapper 1554 may provide for C_{LOSS} in a relative low range, CQI_{DIFF} is equal to 2 and for C_{LOSS} in a relative high range CQI_{DIFF} is equal to 4.

As described in further detail below, a value of CQI_{DIFF} may be calculated for each iteration of a calibration phase and a value of ΔCQI may be determined for a calibration phase and utilized until a subsequent calibration phase. Delta CQI calculator 1556 may be configured to determine a value of ΔCQI for a calibration phase based on each respective CQI_{DIFF} value calculated during the calibration phase. For example, Delta CQI calculator 1556 may calculate ΔCQI as the average of each CQI_{DIFF} for iterations N in a calibration phase as follows:

$$Δ CQI = {\sum }_{i = 1}^{i = N} {CQI}_{diff} / N$$

In one example, each iteration N may correspond to a time interval L configured by the NW. For example, an RRC configuration may indicate a length of a calibration phase. For example, CQI_{DIFF} may be calculated at regular time intervals over a specified time period of a calibration phase and the corresponding N CQI_{DIFF} values may be used (e.g., averaged) to calculate ΔCQI. As provided above, N CQI_{DIFF} values, further in some examples, other functions may be used. In one example, ΔCQI may be set to the minimum of N CQI_{DIFF} values. In one example, ΔCQI may be set to the maximum of N CQI_{DIFF} values. In one example, an infinite impulse response (IIR) exponential filter (also known as an exponential moving average) may be used. That is, ΔCQI may be determined based on the following equation: y[n]=α*x[n]+(1−α)*y[n−1]; where y[n] is the current output, x[n] is the current input, y[n−1] is the previous output, and a is a smoothing factor between 0 and 1. That is, y[n] may be the current ΔCQI, x[n] may be the current CQI_{DIFF}, and y[n−1] may be the previous ΔCQI. Further, it should be noted that when ΔCQI is determined according to an averaging calculation above, or another function which results in a non-integer value, ΔCQI may be truncated to an integer value. Alternatively, the result of CQI_{REF}+(−ΔCQI) may be truncated to an integer value, such that CQI_{REP} is an integer in the range of 0 to 15.

Further, it should be noted that in some examples, Delta CQI Calculator 1556 may be configured such that the value of CQI_{REP}=CQI_{REF}+(−ΔCQI) is not likely to result in a negative value. That is, for example, Delta CQI Calculator 1556 may detect whether a value of ΔCQI is likely to result in a negative value of CQI_{REP} and adjust ΔCQI accordingly. For example, in a case where, a CQI value is in the range of 0 to 15, a relative high value of ΔCQI, (e.g., 10) is likely to result in a negative value for most values of CQI_{REF} and in one example, Delta CQI Calculator 1556 may truncate relatively high values of ΔCQI to a lower value, e.g., values of ΔCQI greater than 8 are truncated to 8. Further, in some examples, UE 106 may report both CQI_{REF} and ΔCQI to BS 102 and may determine whether/how to apply ΔCQI. For example, BS 102 may generate a CQI_{REP} by truncating CQI_{REF}+(−ΔCQI) to a particular value (e.g., truncate to a minimum and/or non-negative value).

As described above, Capacity Loss Calculator 1552 calculates capacity loss, C_{LOSS}, of a DL channel based on differences in channel conditions provided by H_{DL}W_{UE} and H_{DL}W_{NW}. As described above, UE 106 estimates the channel in DL, H_{DL}. H_{DL} may be set equal to H. As further described above, UE 106 performs SVD. That is, H=UΛV, where U and V are unitary matrix and Λ is a diagonal matrix, whose elements are singular values of matrix H. The transmitter applies matrix V as the precoding matrix and the receiver uses U as the detection matrix. Assuming rank L, the ideal precoding matrix may be expressed as V₁=[v(1), v(2) . . . v(L)]. Thus, the effective channel matrix with ideal precoding feedback, as determined by UE 106, can be expressed as H_{eff}=HV₁. Further, a non-ideal precoding matrix may be expressed as V_{C}=[v_{c}(1), v_{c}(2) . . . v_{c}(L)]. Further, an arbitrary precoding matrix can be expressed as P. Thus, a general effective channel matrix can be expressed as HP and for a particular DL transmission P can be set equal to V₁ or a V_{C}.

As described above, in the case of AI/ML-Based Encoding/Decoding P=V₁ may not be practical, as it would correspond to lossless AI/ML-Encoding/Decoding. That is, in the examples provided above, V₁ is equal to W_{UE} and W_{NW} is not equal to W_{UE} due to non-ideal reconstruction (and potential quantization) and as such, W_{NW} is equal to some V_{C}. According to the techniques herein, capacity loss, C_{LOSS}, is derived by comparing HP with P equal to W_{UE} and HP with P equal to W_{NW}.

In general, capacity loss is a function of a receiver at a UE. A receiver at a UE may be based on a receiver model. For example, a receiver at a UE may include one of a Zero-Forcing (ZF) receiver model, a Minimum Mean Square Error (MMSE) receiver model, or an SVD receiver model. For a Zero-Forcing (ZF) receiver model, the precoding matrix, W_{ZF}, and the Signal to Interference & Noise Ratio for each k, where k corresponds to a layer, and L provides the number of layers, SINRₖ, can be expressed as follows:

$${W}_{ZF} = {HP ( {P}^{†} {H}^{†} HP )}^{- 1}$$

$$SIN {R}_{k} = \frac{ρ}{{L [ {( {P}^{†} {H}^{†} HP )}^{- 1} ]}_{kk}}$$

Where ρ is a transmit power.

For a Minimum Mean Square Error (MMSE) receiver model, the precoding matrix, W_{MMSE}, and the Signal to Interference & Noise Ratio for each k, SINR_{K}, can be expressed as follows:

$${W}_{MMSE} = {HP ( \frac{L}{ρ} I + {P}^{†} {H}^{†} HP )}^{- 1}$$

$$SIN {R}_{k} = {{h}_{D}^{†} ( \frac{L}{ρ} I + {H}_{I} {H}_{I}^{†} )}^{- 1} {h}_{D} ,$$

Where, where h_{D} denotes the desired channel: k-th column of HP, and the interference matrix H_{I} is the matrix HP with the k-th column removed.

For an SVD receiver model, the precoding matrix, W_{SVD}, and the Signal to Interference & Noise Ratio for each k, SINRₖ, can be expressed as follows:

$${W}_{SVD} = U$$

$$SIN {R}_{k} = \frac{{\vert {v ( k )}^{†} p ( k ) \vert}^{2}}{{\underbrace{{\sum }_{j = 1 , j \neq k}^{L} {\vert {v ( k )}^{†} p ( j ) \vert}^{2}}}_{Interference} + \frac{L}{{\underbrace{ρ {λ}_{k}}}_{noise}}}$$

The capacity per subcarrier for the three receiving models under inter stream interference can be expressed as:

$$C = {\sum }_{k = 1}^{L} {log}_{2} ( 1 + SIN {R}_{k} )$$

The optimal performance is achieved by using P=V₁ under this condition all receivers can achieve can be expressed as:

$$C = {\sum }_{k = 1}^{L} {log}_{2} ( 1 + {λ}_{k} \frac{ρ}{L} )$$

As described above, in the case of AI/ML-Based Encoding/Decoding P=V₁ may not be practical and P=V_{C} is used where V_{c} is the reconstructed PMI after UE encoding, quantization and NW decoding.

In this manner, according to the techniques herein, C_{LOSS} can be determined as the capacity difference between the capacity with P=V₁, and the capacity with P=V_{C}. That is, C_{LOSS} may be determined according to the following equation:

$${C}_{LOSS} = C {\vert}_{P = {V}_{1}} - C {\vert}_{P = {V}_{c}}$$

An approximate expression for capacity loss at high SNR for an SVD receiver can be derived as:

$${C}_{LOSS , SVD} \approx {\sum }_{k = 1}^{L} {log}_{2} ( \frac{ρ {ρ}_{I} ( k ) {λ}_{k} / L + 1}{{ρ}_{I} ( k ) + {\vert {v ( k )}^{†} p ( k ) \vert}^{2}} )$$

$$Where ,$$

$${ρ}_{I} ( k ) = {\sum }_{j = 1 , j \neq k}^{L} {\vert {v ( j )}^{†} {v}_{c} ( k ) \vert}^{2}$$

is defined as the inter-stream interference to layer k caused by the mismatch between V_{C} and V₁

It should be noted that for rank=1, L=1, there is no stream interference and the capacity loss of an SVD receiver can be approximated as:

$${C}_{LOSS , SVD} \approx - {log}_{2} {\vert {v ( 1 )}^{†} {v}_{c} ( 1 ) \vert}^{2}$$

At high SNR, the performance of ZF and MMSE receivers is the same and consequently both receiving techniques lead to a similar C_{LOSS}, which may be expressed as:

$${C}_{LOSS , ZF / MMSE} \leq {N}_{T} \times \{ {log}_{2} {\sum }_{k - 1}^{{N}_{T}} {\sum }_{j - 1}^{{N}_{T}} {\vert \frac{{λ}_{k}}{{λ}_{j}} {{v}_{c} ( j )}^{†} v ( k ) \vert}^{2} - {log}_{2} {N}_{T} \}$$

In this manner, according to the techniques herein, corresponding values of W_{UE} and W_{NW} may be input into a C_{LOSS} expression for a receiver model and C_{LOSS} may be determined. In this manner, according to the techniques herein, UE 106 compares an optimal channel quality and an actual channel quality and derives a CQI adjustment which is used to determine a CQI value that is reported to BS 102.

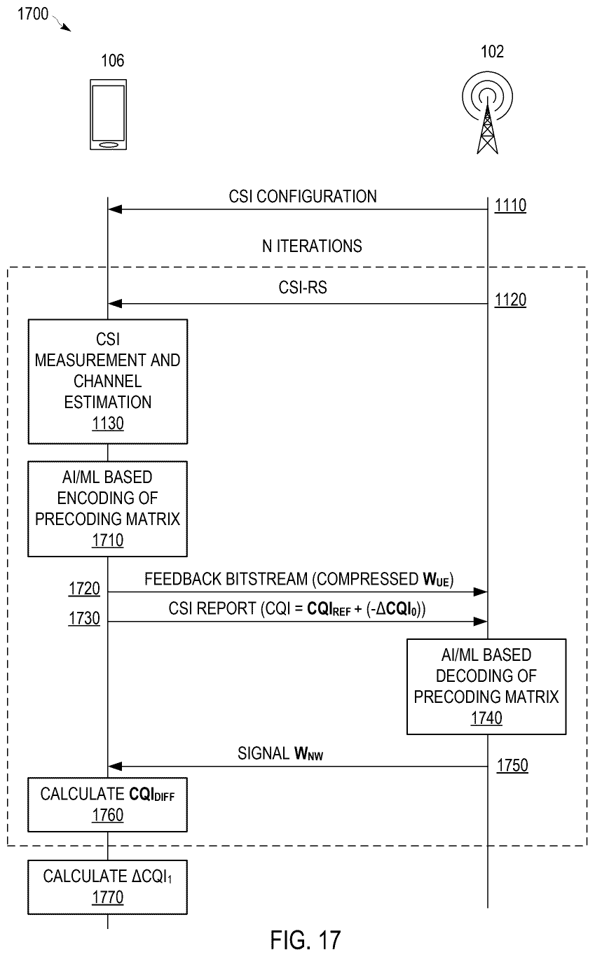

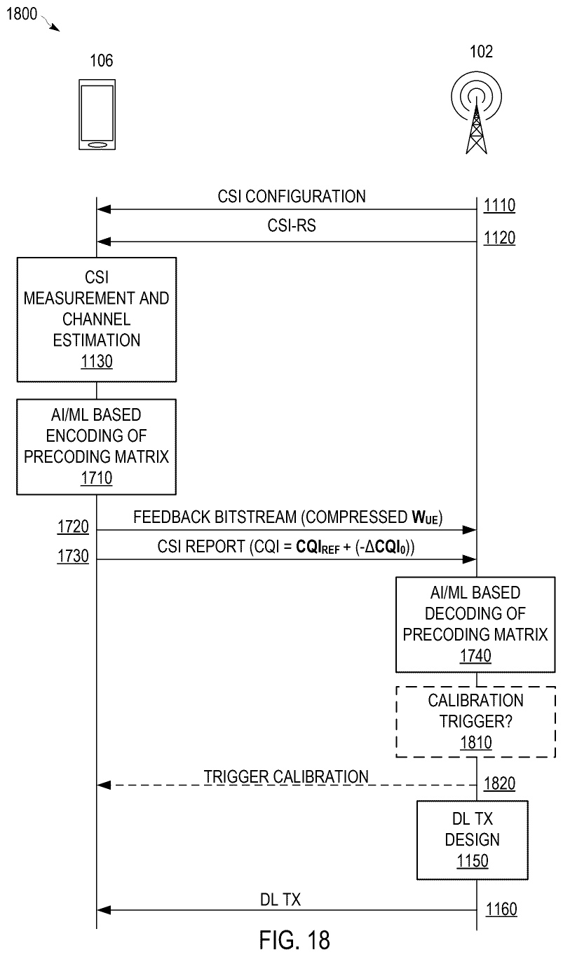

### FIGS. 17 and 18: AI/ML Based CSI Feedback Compression and CQI Determination Procedures

As described above, a value of ΔCQI may be determined for a calibration phase using each respective CQI_{DIFF} value calculated during the calibration phase and utilized until a subsequent calibration phase. FIG. 17 illustrates an example timing diagram 1700 for determining a value of ΔCQI, according to some embodiments. FIG. 18 illustrates an example timing diagram 1800 of utilizing a determined value of ΔCQI, according to some embodiments. That is, FIG. 17 illustrates a calibration phase and FIG. 18 illustrates where a CQI value is determined based on a determined value of ΔCQI.

As illustrated in FIG. 17, a base station 102 (e.g., gNB) transmits a CSI measurement configuration to UE 106 at 1110. As described above, a CSI measurement configuration provides instructions for the UE 106 to measure CSI reference signals (CSI-RS). As described above, according to the techniques herein, the CSI measurement configuration may include information regarding the number of and timing of CQI_{DIFF} value calculations. Base station 102 transmits a CSI-RS to UE 106 at 1120. UE 106 performs measurements on the CSI-RS and performs channel estimation at 1130. At 1710, UE 106 performs AI/ML based encoding of a precoding matrix. For example, as described above, UE 106 may determine a precoding matrix W_{UE} and compress W_{UE} using an AI/ML-Based Encoder, e.g., AI/ML-Based Encoder 1220. At 1720, UE 106 transmits a feedback bitstream including the compressed precoding matrix to BS 102. Further, at 1730, UE 106 transmits a CSI Report including a CQI value to BS 102. It should be noted that during a calibration phase, the CQI value transmitted to BS 102 may be equal to CQI=CQI_{REF}+(−ΔCQI₀) where ΔCQI₀ is the CQI value when a calibration is initiated. For an initial calibration, ΔCQI₀ may be set equal to 0.

At 1740, BS 102 performs AI/ML based decoding of a precoding matrix. For example, as described above, BS 106 may reconstruct a precoding matrix W_{NW} using an AI/ML-Based Decoder, e.g., AI/ML-Based Encoder 1230. At 1750, BS 102 signals the reconstructed precoding matrix to UE 102. In one example, BS 102 may signal the reconstructed precoding matrix to UE 106 using e-type2 signaling or another type of high precision signaling. At 1760, UE 106 calculates a CQI_{DIFF} value. For example, UE 106 may calculate CQI_{DIFF} based on a capacity loss as determined based on differences between W_{UE} and W_{NW}, as described above. As illustrated in FIG. 17, each of 1120 thru 1760 are performed for N iterations. That is, as described above, N instances of CQI_{DIFF} may be determined. At 1770, UE 106 calculates ΔCQI₁, which is an updated calculation of a ΔCQI value compared to ΔCQI₀. For example, UE 106 may calculate ΔCQI₁ according to one or more of the techniques describe above. ΔCQI₁ may be used for determining the CQI value, which is subsequently reported to BS 102, i.e., after the calibration phase is completed.

As describe above, e-type2 signaling or another type of high precision signaling is used by BS 102 to signal the reconstructed precoding matrix W_{NW}. As such, the number of iterations in 1700 and the frequency at which 1700 is performed contributes to signaling overhead. FIG. 18 corresponds to a procedure where a ΔCQI value has been calculated and calibration is not currently being performed. That is, the signaling overhead introduced in 1700 due to calibration is not included in 1800. As illustrated in FIG. 18, a base station 102 (e.g., gNB) transmits a CSI measurement configuration to UE 106 at 1110. Base station 102 transmits a CSI-RS to UE 106 at 1120. UE 106 performs measurements on the CSI-RS and performs channel estimation at 1130. At 1710, UE 106 performs AI/ML based encoding of a precoding matrix, for example, as described above. At 1720, UE 106 transmits a feedback bitstream including the compressed precoding matrix. Further, at 1730, UE 106 transmits a CSI Report including a CQI value to BS 102. It should be noted that during 1800, the CQI value transmitted to BS 102 may be equal to CQI=CQI_{REF}+(−ΔCQI₀) where ΔCQI₀ is a previously calibrated ΔCQI value. At 1740, BS 102, performs AI/ML based decoding of a precoding matrix. For example, as described above, BS 106 may reconstruct a precoding matrix W_{NW} using an AI/ML-Based Decoder.

At 1810, BS 102 may determine whether a calibration trigger has occurred and at 1820, based on a calibration trigger occurring, BS 102 may signal UE 106 to perform a calibration process. That is, signaling at 1820 may cause the calibration process 1700 to be performed. In one example, a calibration trigger may be based on a timer expiring, for example, the calibration process 1700 may be performed periodically. Further, in one example, a calibration process may be based on a reported CQI value and/or values of W_{NW}. For example, if the reported CQI value is a relative low value (e.g., less than 2) or a negative value, BS 102 may trigger a calibration process. Further, in one example, if values of W_{NW} indicate an anomaly, BS 102 may trigger a calibration process.

At 1150, BS 102 may design a downlink transmission based on W_{NW} and the CQI value which is reported by UE 106. That is, for example, BS 102 may select modulation scheme and the code rate based on the CQI value, which is reported by UE 106, which accounts for capacity loss due to W_{NW} being a non-ideal reconstruction of W_{UE}. BS 102 performs the downlink transmission according to the design at 1160.

In this manner, UE 106 and BS 102 may perform processes for determining Channel Quality Indicator (CQI) for Channel State Information (CSI) compression using AI/ML-based models.

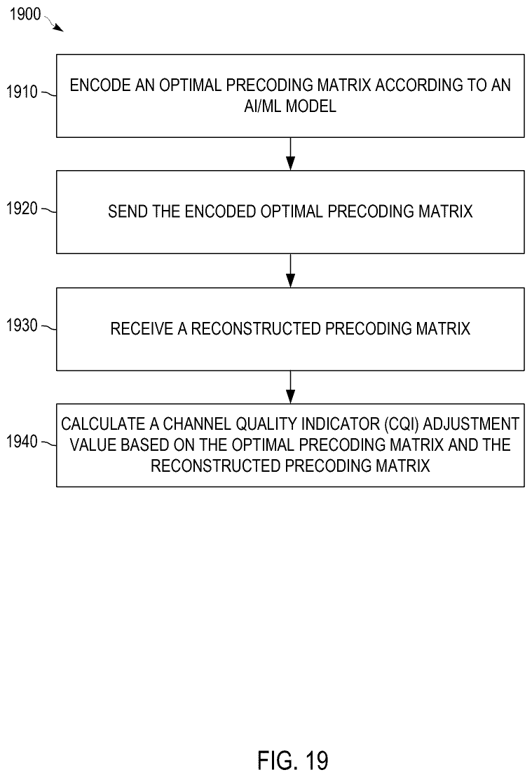

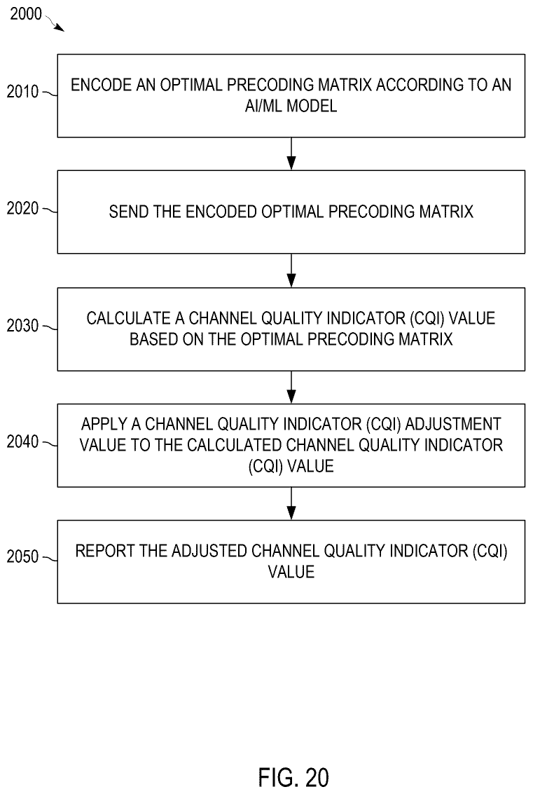

### FIGS. 19 and 20: Methods for Determining Channel Quality Indicator (CQI) for Channel State Information (CSI) Compression Using AI/ML-Based Models in a Wireless Communications Network

FIG. 19 illustrates a block diagram of an example of a method 1900 for determining Channel Quality Indicator (CQI) for Channel State Information (CSI) compression using artificial intelligence (AI)/machine learning (ML)-based models in a wireless communications network, according to some embodiments. The method shown in FIG. 19 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1910, a device in a wireless communications network, for example, a user equipment device (UE), such as UE 106, encodes an optimal precoding matrix according to an AI/ML-based model. For example, a UE may employ an AI/ML-based model for CSI compression as described above.

At 1920, the device may send the encoded optimal precoding matrix. For example, a UE may signal a feedback bitstream to a BS, as described above.

At 1930, the device may receive a reconstructed precoding matrix. For example, a device may receive a reconstructed precoding matrix from a BS, as described above.

At 1940, the device may a calculate a Channel Quality Indicator (CQI) adjustment value based on differences between the optimal precoding matrix and the precoding matrix reconstructed from the encoded optimal precoding matrix. For example, a UE may calculate ΔCQI as described above.

FIG. 20 illustrates a block diagram of an example of a method 2000 for determining Channel Quality Indicator (CQI) for Channel State Information (CSI) compression using artificial intelligence (AI)/machine learning (ML)-based models in a wireless communications network, according to some embodiments. The method shown in FIG. 20 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 2010, a device in a wireless communications network, for example, a user equipment device (UE), such as UE 106, encodes an optimal precoding matrix according to an AI/ML-based model. For example, a UE may employ an AI/ML-based model for CSI compression as described above.

At 2020, the device may send the encoded optimal precoding matrix. For example, a UE signal a feedback bitstream to a BS, as described above.

At 2030, the device may calculate a Channel Quality Indicator (CQI) value based on the optimal precoding matrix. For example, a UE may calculate CQI_{REF}, as described above.

At 2040, the device may apply a Channel Quality Indicator (CQI) adjustment value to the calculated Channel Quality Indicator (CQI) value. For example, a UE may reduce CQI_{REF} by ΔCQI, as described above.

At 2050, the device may report the adjusted Channel Quality Indicator (CQI) value. For example, a UE may report CQI_{REP} to a BS, as described above.

In some examples, calculating a Channel Quality Indicator (CQI) adjustment value based on differences between the optimal precoding matrix and the precoding matrix reconstructed from the encoded optimal precoding matrix includes calculating a capacity loss of a downlink (DL) channel based on differences in channel conditions provided by the optimal precoding matrix and the reconstructed precoding matrix.

In some examples, calculating a capacity loss includes approximating a capacity loss based on values provided by the optimal precoding matrix and the reconstructed precoding matrix.

In some examples, calculating a capacity loss includes calculating a capacity loss based on a Signal-to-Interference-plus-Noise Ratio (SINR) calculation provided for a receiver model.

In some examples, a receiver model includes one of a Zero Forcing (ZF) receiver model, a Minimum Mean Square Error (MMSE) receiver model, and a Singular Value Decomposition (SVD) receiver model.

In some examples, calculating a Channel Quality Indicator (CQI) adjustment value further includes mapping a calculated capacity loss to a Channel Quality Indicator (CQI) difference value.

In some examples, calculating a Channel Quality Indicator (CQI) adjustment value further includes calculating a Channel Quality Indicator (CQI) adjustment value by averaging a number of Channel Quality Indicator (CQI) difference values, wherein the number of Channel Quality Indicator (CQI) difference values is based on a number of iterations performed during a calibration phase.

In some examples, each iteration corresponds to a time interval specified by the base station (BS).

In some examples, applying a Channel Quality Indicator (CQI) adjustment value includes reducing the calculated Channel Quality Indicator (CQI) value.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that, in some embodiments, data used by Channel Quality Indicator (CQI) determination processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to, data used in association with Channel Quality Indicator (CQI) determination processes, should attempt to comply with well-established privacy policies and/or privacy practices.

For example, such entities may implement and consistently follow policies and practices recognized as meeting or exceeding industry standards and regulatory requirements for developing and/or training Channel Quality Indicator (CQI) determination processes. In doing so, attempts should be made to ensure all intellectual property rights and privacy considerations are maintained. Training should include practices safeguarding training data, such as personal information, through sufficient protections against misuse or exploitation. Such policies and practices should cover all stages of the Channel Quality Indicator (CQI) determination processes development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, Channel Quality Indicator (CQI) determination processes may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for Channel Quality Indicator (CQI) determination processes may be kept strictly separated from platforms where the Channel Quality Indicator (CQI) determination processes are deployed and/or used to interact with users and/or process data. In such embodiments, data used for offline training of the Channel Quality Indicator (CQI) determination processes may be maintained in secured datastores with restricted access and/or not be retained beyond the duration necessary for training purposes. In some embodiments, Channel Quality Indicator (CQI) determination processes may utilize a local memory cache to store data temporarily during a user session. The local memory cache may be used to improve performance of the Channel Quality Indicator (CQI) determination processes. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the Channel Quality Indicator (CQI) determination processes. The Channel Quality Indicator (CQI) determination processes should be monitored for changes in underlying data distribution such as concept drift or data skew that can degrade performance of the Channel Quality Indicator (CQI) determination processes over time.

In some embodiments, the Channel Quality Indicator (CQI) determination processes are trained using a combination of offline and online training. Offline training can use curated datasets to establish baseline model performance, while online training can allow the Channel Quality Indicator (CQI) determination processes to continually adapt and/or improve. The present disclosure recognizes the importance of maintaining strict data governance practices throughout this process to ensure user privacy is protected.

In some embodiments, the Channel Quality Indicator (CQI) determination processes may be designed with safeguards to maintain adherence to originally intended purposes, even as the Channel Quality Indicator (CQI) determination processes adapt based on new data. Any significant changes in data collection and/or applications of Channel Quality Indicator (CQI) determination process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the Channel Quality Indicator (CQI) determination processes and/or for use as input during the inference stage of such systems. In yet another example, the present technology should be configured to allow users to be able to select to limit the length of time data is maintained or entirely prohibit the use of their data for use by the Channel Quality Indicator (CQI) determination processes. In addition to providing “opt in” and “opt out” options, the present disclosure contemplates providing notifications relating to the access or use of personal information. For instance, a user can be notified when their data is being input into the Channel Quality Indicator (CQI) determination processes for training or inference purposes, and/or reminded when the Channel Quality Indicator (CQI) determination processes generate outputs or make decisions based on their data.

The present disclosure recognizes Channel Quality Indicator (CQI) determination processes should incorporate explicit restrictions and/or oversight to mitigate against risks that may be present even when such systems have been designed, developed, and/or operated according to industry's best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the Channel Quality Indicator (CQI) determination processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the Channel Quality Indicator (CQI) determination processes should refrain from using the services in any manner that infringes upon, misappropriates, or violates the rights of any party. Furthermore, the Channel Quality Indicator (CQI) determination processes should not be used for any unlawful or illegal activity, nor to develop any application or use case that would commit or facilitate the commission of a crime, or other tortious, unlawful, or illegal act including misinformation, disinformation, misrepresentations (e.g., deep fakes), deception, impersonation, and propaganda. The Channel Quality Indicator (CQI) determination processes should not violate, misappropriate, or infringe any copyrights, trademarks, rights of privacy and publicity, trade secrets, patents, or other proprietary or legal rights of any party, and appropriately attribute content as required. Further, the Channel Quality Indicator (CQI) determination processes should not interfere with any security, digital signing, digital rights management, content protection, verification, or authentication mechanisms. The Channel Quality Indicator (CQI) determination processes should not misrepresent machine-generated outputs as being human-generated

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) including one or more baseband processors and one or more application processors and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for determining Channel Quality Indicator (CQI) for Channel State Information (CSI) compression using artificial intelligence (AI)/machine learning (ML)-based models at a User Equipment (UE) in a wireless communications network, the method comprising:
encoding an optimal precoding matrix according to an AI/ML-based model;
sending the encoded optimal precoding matrix to a base station (BS);
receiving, at the UE, a precoding matrix reconstructed from the encoded optimal precoding matrix from the base station (BS); and
calculating a Channel Quality Indicator (CQI) adjustment value based on differences between the optimal precoding matrix and the precoding matrix reconstructed from the encoded optimal precoding matrix.

2. The method of claim 1, wherein calculating a Channel Quality Indicator (CQI) adjustment value based on differences between the optimal precoding matrix and the precoding matrix reconstructed from the encoded optimal precoding matrix includes calculating a capacity loss of a downlink (DL) channel based on differences in channel conditions provided by the optimal precoding matrix and the reconstructed precoding matrix.

3. The method of claim 2, wherein calculating a capacity loss includes approximating a capacity loss based on values provided by the optimal precoding matrix and the reconstructed precoding matrix.

4. The method of claim 2, wherein calculating a capacity loss includes calculating a capacity loss based on a Signal-to-Interference-plus-Noise Ratio (SINR) calculation provided for a receiver model.

5. The method of claim 4, wherein a receiver model includes one of a Zero Forcing (ZF) receiver model, a Minimum Mean Square Error (MMSE) receiver model, and a Singular Value Decomposition (SVD) receiver model.

6. The method of claim 2, wherein calculating a Channel Quality Indicator (CQI) adjustment value further includes mapping a calculated capacity loss to Channel Quality Indicator (CQI) difference values.

7. The method of claim 6, wherein calculating a Channel Quality Indicator (CQI) adjustment value further includes calculating the Channel Quality Indicator (CQI) adjustment value by averaging a number of Channel Quality Indicator (CQI) difference values, wherein the number of Channel Quality Indicator (CQI) difference values is based on a number of iterations performed during a calibration phase.

8. The method of claim 7, wherein each iteration corresponds to a time interval specified by the base station (BS).

9. A method for determining Channel Quality Indicator (CQI) for Channel State Information (CSI) compression using artificial intelligence (AI)/machine learning (ML)-based models at a User Equipment (UE) in a wireless communications network, the method comprising:
encoding an optimal precoding matrix according to an AI/ML-based model;
sending the encoded optimal precoding matrix to a base station (BS);
calculating a Channel Quality Indicator (CQI) value, wherein the Channel Quality Indicator (CQI) value is based on the optimal precoding matrix;
applying a Channel Quality Indicator (CQI) adjustment value to the calculated Channel Quality Indicator (CQI) value; and
reporting an adjusted Channel Quality Indicator (CQI) to the base station (BS).

10. The method of claim 9, wherein applying a Channel Quality Indicator (CQI) adjustment value includes reducing the calculated Channel Quality Indicator (CQI) value.

11. An apparatus of a user equipment (UE) configured to determine Channel Quality Indicator (CQI) for Channel State Information (CSI) compression using artificial intelligence (AI)/machine learning (ML)-based models at a User Equipment (UE) in a wireless communications network, the apparatus comprising:
one or more processors configured to:
encode an optimal precoding matrix according to an AI/ML-based model;
send the encoded optimal precoding matrix to a base station (BS);
calculate a Channel Quality Indicator (CQI) value, wherein the Channel Quality Indicator (CQI) value is based on the optimal precoding matrix;
apply a Channel Quality Indicator (CQI) adjustment value to the calculated Channel Quality Indicator (CQI) value; and
report an adjusted Channel Quality Indicator (CQI) to the base station (BS).

12. The apparatus of claim 11, wherein applying a Channel Quality Indicator (CQI) adjustment value includes reducing the calculated Channel Quality Indicator (CQI) value.

13. The apparatus of claim 11, wherein the one or more processors are further configured to:
receive a precoding matrix reconstructed from the encoded optimal precoding matrix from the base station (BS); and
calculate the Channel Quality Indicator (CQI) adjustment value based on differences between the optimal precoding matrix and the precoding matrix reconstructed from the encoded optimal precoding matrix.

14. The apparatus of claim 13, wherein calculating a Channel Quality Indicator (CQI) adjustment value based on differences between the optimal precoding matrix and the precoding matrix reconstructed from the encoded optimal precoding matrix includes calculating a capacity loss of a downlink (DL) channel based on differences in channel conditions provided by the optimal precoding matrix and the reconstructed precoding matrix.

15. The apparatus of claim 14, wherein calculating a capacity loss includes approximating a capacity loss based on values provided by the optimal precoding matrix and the reconstructed precoding matrix.

16. The apparatus of claim 14, wherein calculating a capacity loss includes calculating a capacity loss based on a Signal-to-Interference-plus-Noise Ratio (SINR) calculation provided for a receiver model.

17. The apparatus of claim 16, wherein a receiver model includes one of a Zero Forcing (ZF) receiver model, a Minimum Mean Square Error (MMSE) receiver model, and a Singular Value Decomposition (SVD) receiver model.

18. The apparatus of claim 13, wherein calculating a Channel Quality Indicator (CQI) adjustment value further includes mapping a calculated capacity loss to a Channel Quality Indicator (CQI) difference value.

19. The apparatus of claim 18, wherein calculating a Channel Quality Indicator (CQI) adjustment value further includes calculating the Channel Quality Indicator (CQI) adjustment value by averaging a number of Channel Quality Indicator (CQI) difference values, wherein the number of Channel Quality Indicator (CQI) difference values is based on a number of iterations performed during a calibration phase.

20. The apparatus of claim 19, wherein each iteration corresponds to a time interval specified by the base station (BS).

21.-27. (canceled)
